(19) United States
(12) Patent Application Publication
(10) Pub. No.: US 2012/0181463 A1
(43) Pub. Date: Jul. 19, 2012

(54) SHUT-OFF VALVE

(75) Inventors: Thomas KLEEGREWE, Minden (DE); Wolfgang Scholz, Minden (DE)

(73) Assignee: ABB Technology AG, Zurich (CH)

(21) Appl. No.: 13/336,210

(22) Filed: Dec. 23, 2011

(30) Foreign Application Priority Data
Dec. 24, 2010 (DE) 102010056277.7

(51) Int. Cl. F16K 31/02; F16K 47/02

(52) U.S. Cl. 251/129.04

(57) ABSTRACT

A shut-off fitting is disclosed for use, for example, in a pipeline of a technical installation with a servo drive. The servo drive can be connected to a control device having a position controller and a signal conditioner device. The position controller can have an analog control input for connecting a process control signal and a binary control input for actuating the servo drive in accordance with a predeterminable speed characteristic. The signal conditioner device can have a feed voltage input, an analog control output, a binary control output, and an energy store.

### RELATED APPLICATION

This application claims priority under 35 U.S.C. §119 to German Patent Application No. 102010056277.7 filed in Europe on Dec. 24, 2010, the entire content of which is hereby incorporated by reference in its entirety.

### BACKGROUND INFORMATION

A shut-off fitting is disclosed in a pipeline in a technical installation.

Shut-off fittings are actuating devices for flowing materials which completely interrupt or completely enable these flows of material without any intermediate positions. Such shut-off fittings can be in the form of valves, ball valves, ball segment valves or tap cocks since these only have very low pressure and therefore energy losses in the fully open state.

Fittings of this generic type have a flow characteristic in which the flow in the region of small opening cross sections react to small adjustments steps with overproportionally large changes in flow. This response is reversed in the region of large opening cross sections (i.e., even large adjustment steps), and therefore large changes in the clear cross section, have the effect of comparatively marginal changes in flow. An example is fittings with a characteristic of the same percentage value in which a defined adjustment step brings about a defined percentage change in the clear cross section.

For installations in which large mass flows are to be controlled, this response can be very problematic during closing of the fitting owing to the mass inertia and the energy stored therein. In an exemplary worst case scenario, uncontrolled closing results in a water hammer, pressure peaks, which leads to excessive loading on or destruction of the fitting, and pipe implosion as a result of the subatmospheric pressure which is produced downstream of the fitting as a result of the mass continuing to flow without being braked. Uncontrolled opening of a fitting can be critical in applications in which components at risk of water hammer are arranged downstream of a fitting.

It is known to adjust the position of fittings with the aid of position controllers. For example, DE 10124847 A1 has disclosed that digital electropneumatic position controllers implement functions internally which modify a setpoint value signal, for example by temporal, linear dilation Xᵢₙₜ=f(t)*Xₑₓₜ) by way of a ramp function or mapping the external setpoint value onto an internal setpoint value by a predefined or freely configurable characteristic function Xᵢₙₜ=f(Xₑₓₜ).

In addition, the electropneumatic position controller TZIDC by ABB, described in the configuration and parameterization instructions, document number 45/18-79-DE, in particular page 71, has an additional digital input, to which a protective function can be assigned, whereupon the servo drive, upon activation of this digital input taking into consideration a setpoint value ramp, a set working range and a selected response in the end position, is moved to a fixed position.

Known technical solutions are software functions of the digital position controller in which the fitting moves in uncontrolled fashion when there is no actuating signal, and therefore no power supply, such that the risk of water hammer still exists.

A position controller is therefore disclosed wherein the controlled shut-off fitting can move reliably into a predetermined shut-off position even in the event of a failure in the power supply.

### SUMMARY

A shut-off fitting is disclosed for a pipeline in a technical installation with a servo drive, comprising: a control device for connection to a servo drive, the control device having: a position controller with an analog control input for connecting a process control signal, and a binary control input for actuating a servo drive in accordance with a predeterminable speed characteristic; and a signal conditioner device with a feed voltage input, an analog control output connected to the feed voltage input via a first signal conditioner, a binary control output connected to the feed voltage input via a second signal conditioner, and an energy store, wherein the analog control output of the signal conditioner device is connected to the analog control input of the position controller, and the binary control output of the signal conditioner device is connected to the binary control input of the position controller.

### BRIEF DESCRIPTION OF THE DRAWINGS

The invention will be explained in detail below with reference to an exemplary embodiment. In the related drawings:

FIG. 1 shows a basic illustration of an exemplary shut-off fitting; and

FIG. 2 shows a detail illustration of an exemplary control device of the shut-off fitting.

### DETAILED DESCRIPTION

A shut-off fitting is known per se in a pipeline in a technical installation which is connected to a servo drive for actuation thereof.

According to exemplary embodiments disclosed herein, the servo drive is connected to a control device, which includes a position controller (e.g., a known position controller) and a signal conditioner device. The position controller can have an analog control input for connecting a process control signal and a binary control input for actuating the servo drive in accordance with a predeterminable speed characteristic. The signal conditioner device can have a feed voltage input, an analog control output, which is connected to the feed voltage input via a first signal conditioner, a binary control output, which is connected to the feed voltage input via a second signal conditioner, and an energy store. The analog control output of the signal conditioner device is connected to the analog control input of the position controller, and the binary control output of the signal conditioner device is connected to the binary control input of the position controller.

The first signal conditioner derives a predeterminable, constant process control signal from the voltage at the feed voltage input. The second signal conditioner inverts the logic level at the binary control output in the event of a predeterminable limit value of the voltage at the feed voltage input being undershot.

During exemplary correct use of the shut-off fitting in the rest position thereof, a minimum voltage is present at the feed voltage input of the signal conditioner device. A process control signal is derived from the feed voltage with the aid of the first signal conditioner, the process control signal corresponding to the rest position of the shut-off fitting. Furthermore, the effect of the predeterminable speed characteristic is deactivated with the aid of the second signal conditioner.

As soon as the feed voltage at the feed voltage input of the signal conditioner device undershoots a minimum voltage, the shut-off fitting is moved into its predetermined shut-off position by virtue of the level of the binary control output of the signal conditioner device being inverted, whilst maintaining the process control signal from the energy store, whereupon the servo drive moves the shut-off fitting into the secure shut-off position, in accordance with a predetermined speed characteristic.

The predeterminable characteristic function enables a shut-off fitting to be set quickly in setting ranges with an uncritical pressure increase as well as setting in a controlled manner in such a way as to limit the pressure increase in the critical setting ranges. Advantageously, the shut-off fitting can in this case be closed as quickly as possible and therefore as safely as desired and/or specified.

An exemplary signal conditioner device can include a compressed air store. This means that the shut-off fitting can move into the safe shut-off position even in the event of a failure of the pneumatic energy.

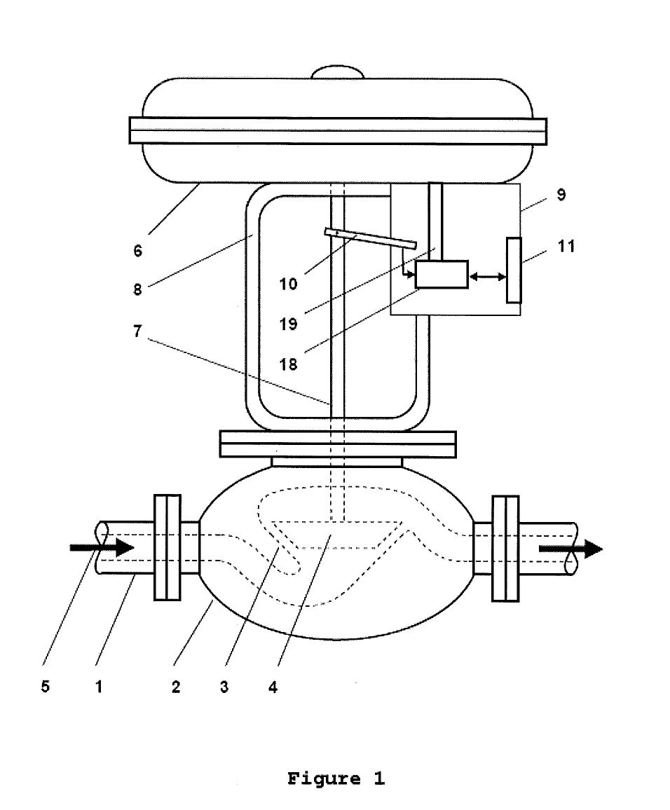

Referring to FIG. 1, by way of example a process valve 2 in the form of an actuating element is built into a pipeline 1 (of which a fragment is shown) of a process-engineering installation (not shown in detail). The process valve 2 has a closing body 4, which interacts with a valve seat 3, in its interior for controlling the quantity of process medium 5 passing through. The closing body 4 is actuated linearly by a pneumatic servo drive 6 via a lifting rod 7. The servo drive 6 is connected to the process valve 2 via a yoke 8. A control device 9 is fitted to the yoke 8. The excursion of the lifting rod 7 is signalled to the control device 9 via a position pickup 10. The detected excursion is compared with a setpoint value in the position controller 18 and drives the servo drive 6 depending on the system deviation determined. The position controller 18 of the control electronics 9 operates an I/P converter for converting an electric system deviation into an adequate control pressure. The I/P converter of the position controller 18 is connected to the servo drive 6 via a pressure medium supply line 19.

The position pickup 10 is connected to the rotary spindle of a potentiometer in the position controller 18 and has an eyelet in which a driver on the lifting rod 7 engages.

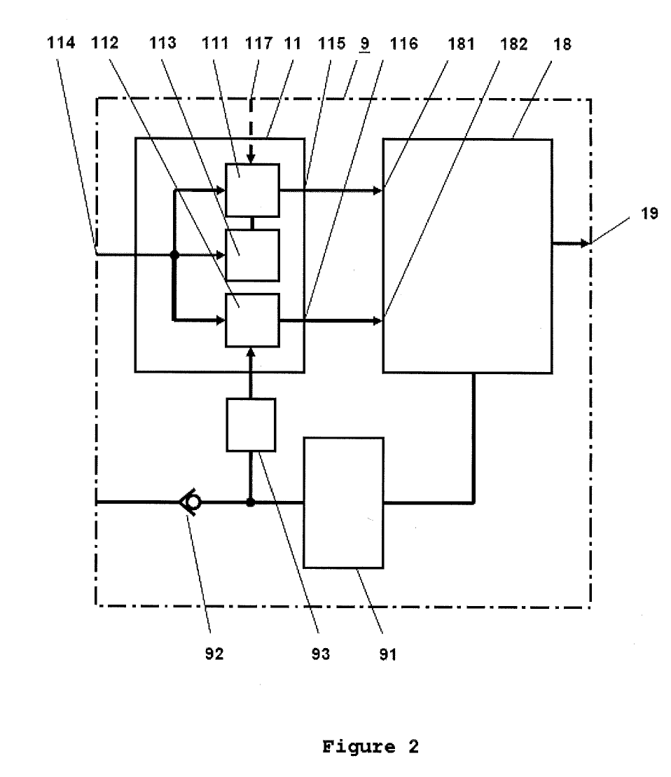

FIG. 2 illustrates a detail of an exemplary control device 9 of the shut-off fitting. The control device 9 includes a position controller 18, which can be known per se, and a signal conditioner device 11. The position controller 18 has an analog control input 181 for connecting a process control signal and a binary control input 182 for actuating the servo drive 6 in accordance with a predeterminable speed characteristic. The signal conditioner device 11 has a feed voltage input 114, an analog control output 115, which is connected to the feed voltage input 114 via a first signal conditioner 111, a binary control output 116, which is connected to the feed voltage input 114 via a second signal conditioner 112, and an energy store 113.

The analog control output 115 of the signal conditioner device 11 is connected to the analog control input 181 of the position controller 18, and the binary control output 116 of the signal conditioner device 11 is connected to the binary control input 182 of the position controller 18.

The first signal conditioner 111 derives a predeterminable, constant process control signal from the voltage at the feed voltage input 114. The second signal conditioner 112 inverts the logic level at the binary control output 116 in the event of a predeterminable limit value of the voltage at the feed voltage input 114 being undershot.

During correct use of the shut-off fitting in the rest position thereof, a minimum voltage is present at the feed voltage input 114 of the signal conditioner device 11. A process control signal is derived from the feed voltage with the aid of the first signal conditioner 111, the process control signal corresponding to the rest position of the shut-off fitting. Furthermore, the effect of the predeterminable speed characteristic is deactivated with the aid of the second signal conditioner 112.

As soon as the feed voltage at the feed voltage input 114 of the signal conditioner device 11 undershoots a minimum voltage, the shut-off fitting is moved into its predetermined shut-off position by virtue of the level of the binary control output 116 of the signal conditioner device 11 being inverted whilst maintaining the process control signal from the energy store 113, whereupon the servo drive 6 moves the shut-off fitting into the safe shut-off position, in accordance with a predetermined speed characteristic.

The predeterminable characteristic function enables a shut-off fitting to be set quickly in setting ranges with an uncritical pressure increase as well as setting in a controlled manner in such a way as to limit the pressure increase in the critical setting ranges. Advantageously, the shut-off fitting can in this case be closed as quickly as possible and therefore as safely as required.

In an advantageous exemplary configuration, the signal conditioner device 11 is in the form of an intrinsically safe electronic circuit, which is fed via a discrete signal which generally serves to feed a pneumatic solenoid valve, for example 24 V. This signal conditioner device 11 feeds the position controller 18 at its analog control input 181 with an exemplary constant 4 mA/9.7 V.

In a further exemplary configuration, as is illustrated by dashed lines in FIG. 2, the signal conditioner device 11 is also connected to a process control signal input 117. A variable process control signal is connected to this process control signal input 117, the process control signal predetermining the setpoint position for the shut-off fitting which is impressed, for example, on a 4.20 mA signal, known per se.

During correct use of the shut-off fitting in the rest position thereof, the process control signal input 117 of the signal conditioner device 11 is connected to the analog control output 115. Therefore, the analog control input 181 of the position controller 18 is controlled by the variable process control signal. The shut-off fitting is positioned depending on this variable process control signal.

As soon as the feed voltage at the feed voltage input 114 of the signal conditioner device 11 undershoots a minimum voltage, the shut-off fitting is moved into its predetermined shut-off position by virtue of the level of the binary control output 116 of the signal conditioner device 11 being inverted independently of the variable process control signal from the energy store 113, whereupon the servo drive 6 moves the shut-off fitting into the safe shut-off position in accordance with a predetermined speed characteristic.

In an exemplary configuration, the signal conditioner device 11 feeds the position controller 18 at its analog control input 181 with an exemplary constant 4 mA/9.7 V.

In addition, the signal conditioner device 11 in exemplary embodiments feeds the binary input 181 of the position controller 18 with a “logic 1” signal. The remaining available energy flows into the integrated energy store 113 for electrical energy. The energy store 113 can, for example, be in the form of a known capacitor, Goldcap capacitor or rechargeable battery or other energy store.

The exemplary position controller 18 can be configured such that the 4 mA signal at its analog control input 181 represents the desired shut-off position of the fitting and the “logic 1” signal at its binary input 182 represents a desired operating position of the fitting.

As the binary input 182 is switched over to “logic 0”, the fitting can be stretched temporally and is moved into the shut-off position, corresponding to the set characteristic.

In a further exemplary embodiment, the signal conditioner device 11 has a compressed air store 91, which is fitted in series in the pneumatic supply line of the position controller 18. If the supply pressure of the compressed air store 91 undershoots a predetermined limit value, a nonreturn valve 92 seals off the compressed air store 91 and position controller 18 with respect to the supply air. The compressed air store 91 now provides the pneumatic energy for the position controller 18. The switching of the nonreturn valve 92 at the same time actuates an electrical pressure-operated switch 93, which interrupts the signal line to the electronic circuit in the event of a drop in pressure and closes given a sufficient pressure.

In this case, provision can be made for the pressure-operated switch 93 to be arranged downstream of the nonreturn valve 92, as illustrated in FIG. 2. Advantageously, unintentional closing of the shut-off fitting in the event of short-term fluctuations in the feed pressure can thus be avoided.

In an alternative exemplary embodiment, provision can be made for the pressure-operated switch 93 to be arranged upstream of the nonreturn valve 92. Advantageously, the failure of the feed pressure thus can be identified more quickly.

All of the energy stores 91 and 113 of the control device 9 can be dimensioned such that the position controller 18 controls the shut-off fitting and moves it safely into the shut-off position.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Pipeline

2 Process valve

3 Valve seat

4 Closing body

5 Process medium

6 Servo drive

7 Valve rod

8 Yoke

9 Control device

91 Compressed air store

92 Nonreturn valve

93 Pressure-operated switch

10 Position pickup

11 Signal conditioner device

111, 112 Signal conditioners

113 Energy store

114 Feed voltage input

115 Analog control output

116 Binary control output

117 Process control signal input

18 Position controller

181 Analog input

182 Binary input

19 Pressure medium supply line

1. A shut-off fitting for a pipeline in a technical installation with a servo drive, comprising:
a control device for connection to a servo drive, the control device having:
a position controller with an analog control input for connecting a process control signal, and a binary control input for actuating a servo drive in accordance with a predeterminable speed characteristic; and
a signal conditioner device with a feed voltage input, an analog control output connected to the feed voltage input via a first signal conditioner, a binary control output connected to the feed voltage input via a second signal conditioner, and an energy store, wherein the analog control output of the signal conditioner device is connected to the analog control input of the position controller, and the binary control output of the signal conditioner device is connected to the binary control input of the position controller.

2. The shut-off fitting as claimed in claim 1, wherein the first signal conditioner is configured to derive a predeterminable, constant process control signal from the voltage at the feed voltage input.

3. The shut-off fitting as claimed in claim 2, wherein the first signal conditioner comprises:
a switching apparatus and a comparator for maintaining a predeterminable, constant process control signal from the energy store in an event of a predeterminable limit value of a voltage at the feed voltage input being undershot until a blocking operation of the shut-off fitting is complete.

4. The shut-off fitting as claimed in claim 1, wherein the second signal conditioner comprises:
a comparator for inverting a logic level at the binary control output in an event of a predeterminable limit value of a voltage at the feed voltage input being undershot.

5. The shut-off fitting as claimed in claim 1, wherein the signal conditioner device comprises:
a compressed air store.

6. The shut-off fitting as claimed in claim 1, wherein the first signal conditioner is connected to a process control signal input.

7. The shut-off fitting of claim 1, in combination with a servo drive connected with the control device.

8. The shut-off fitting as claimed in claim 3, wherein the second signal conditioner comprises:
a comparator for inverting a logic level at the binary control output in an event of a predeterminable limit value of a voltage at the feed voltage input being undershot.

9. The shut-off fitting as claimed in claim 8, wherein the signal conditioner device comprises:
a compressed air store.

10. The shut-off fitting as claimed in claim 6, wherein the first signal conditioner is connected to a process control signal input.
